(19) United States
(12) Patent Application Publication
(10) Pub. No.: US 2024/0066823 A1
(43) Pub. Date: Feb. 29, 2024

(54) TIRE CONICITY CORRECTION DEVICE AND TIRE CONICITY CORRECTION METHOD

(71) Applicant: Toyo Tire Corporation, Itami-shi (JP)

(72) Inventor: Toshikazu Yasunaga, Itami-shi (JP)

(73) Assignee: Toyo Tire Corporation, Itami-shi (JP)

(21) Appl. No.: 18/141,021

(22) Filed: Apr. 28, 2023

(30) Foreign Application Priority Data
Aug. 25, 2022 (JP) 2022-134281

(51) Int. Cl. B29D 30/06

(52) U.S. Cl. CPC B29D 30/0633; B29D 2030/0639

(57) ABSTRACT

A tire conicity correction device has a base member on which a tire is horizontally placed with a tire axial direction coincident with a vertical direction, a heater configured to heat the base member, and a tire side support surface provided on the base member to support a side outer surface of the tire. The tire side support surface includes a first curved surface curved along a profile of the side outer surface of the tire.

### FIELD OF THE INVENTION

### Cross-Reference to Related Applications

The present application claims priority based on Japanese Patent Application No. 2022-134281 filed on Aug. 25, 2022, the contents of which are incorporated herein by reference in its entirety.

The present disclosure relates to a tire conicity correction device and a tire conicity correction method.

### Description of the Related Art

Tire uniformity is one of important properties related to various tire performances such as fuel efficiency (rolling resistance) and noise performance. Conicity, which is a type of uniformity, is a lateral force produced in a tire axial direction when a tire rolls under loaded conditions, and affects straight-line stability of the tire. When a difference between left and right outer diameters of a tire after cure molding is excessively large, conicity tends to deteriorate.

A tire deviating from a predetermined standard value in uniformity inspection is temporarily removed from a shipment line and transferred to a correction process for rework. In the related art, as a rework for correcting uniformity including conicity, buffing a part of an outer surface of the tire is known. There is, however, a possibility that the buffering may impair the appearance of the tire, and thus the scope of practical application is considerably limited.

On the other hand, Patent Document 1 discloses a method for correcting conicity by giving different thermal histories to a pair of tire half portions divided by a tire equatorial plane. The method, however, is a method in which a tire assembled to a rim is airtightly placed in a split housing split into two parts, and a heating gas and a cooling gas are sequentially fed to the housing, so that the method requires a complicated device and a process, and it can be said that the method is often not suitable for practical use from the viewpoint of cost efficiency, workability, and the like.

The inventor of the present invention has found that relatively slight conicity can be corrected by appropriately heating the tire half portion without using such an exaggerated method as disclosed in Patent Document 1. In order to heat the tire half portion, it is, however, necessary to efficiently transfer heat to a required area of the tire half portion so as to prevent a rework time from becoming unnecessarily long and a correction effect from becoming small, but a specific method suitable for the heat transfer is not known.

### PRIOR ART DOCUMENT

### Patent Document

Patent Document 1: JP-A-2000-280264

### SUMMARY OF THE INVENTION

The present disclosure has been made in view of the above-described circumstances, and it is therefore an object of the present disclosure to provide a conicity correction device and a conicity correction method capable of correcting tire conicity with ease.

A tire conicity correction device of the present disclosure includes a base member on which a tire is horizontally placed with a tire axial direction coincident with a vertical direction, a heater configured to heat the base member, and a tire side support surface provided on the base member to support a side outer surface of the tire, and the tire side support surface includes a first curved surface curved along a profile of the side outer surface of the tire.

Further, a tire conicity correction method of the present disclosure includes horizontally placing a tire on a base member that has been heated with a tire axial direction coincident with a vertical direction and performing heating with a tire side support surface of the base member supporting a side outer surface of the tire, and the tire side support surface includes a first curved surface curved along a profile of the side outer surface of the tire.

### BRIEF DESCRIPTION OF THE DRAWINGS

FIG. 1 is a schematic front view of an example of a conicity correction device;

FIG. 2 is a cross-sectional view of an example of a tire;

FIG. 3 is an enlarged view of a main part of FIG. 1; and

FIG. 4 is an exploded half cross-sectional view of a base member.

### DETAILED DESCRIPTION OF THE PREFERRED EMBODIMENTS

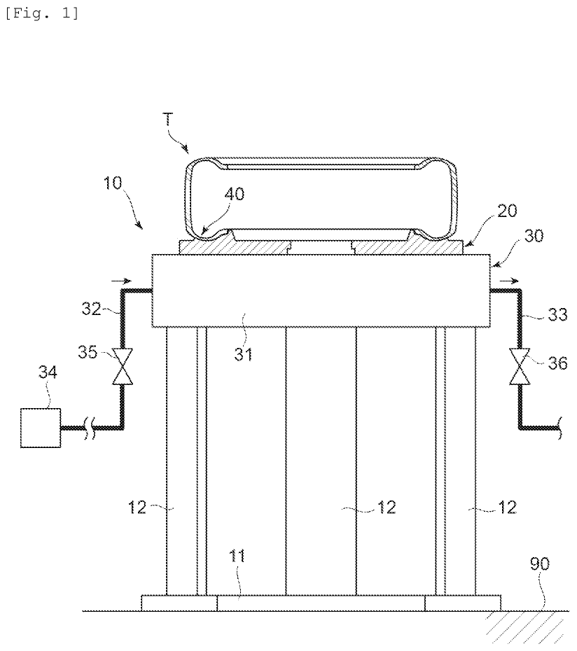

FIG. 1 is a schematic front view of an example of a conicity correction device. In the conicity correction device 10, a tire T is set with the tire T not mounted on a rim. The tire T is placed not in a closed space such as a housing but in an open space in a room. The conicity correction device 10 includes a base member 20 on which the tire T is horizontally placed with a tire axial direction coincident with a vertical direction, a heater 30 that heats the base member 20, and a tire side support surface 40 provided on the base member 20 to support a side outer surface of the tire T. The tire T and the base member 20 illustrated in FIG. 1 are each drawn in cross section.

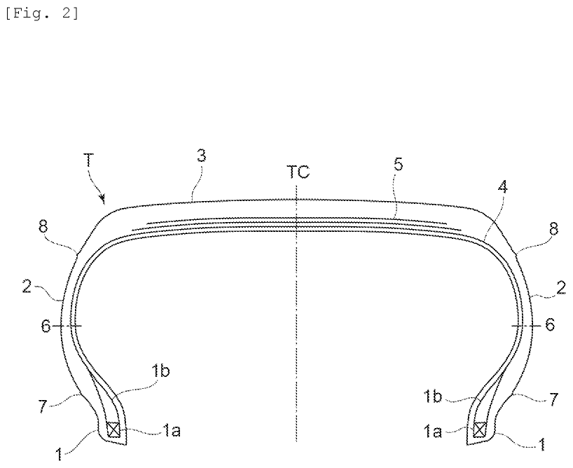

FIG. 2 illustrates an example of a cross section of the tire T. In the drawings other than FIG. 2, illustration of an internal structure of the tire T is omitted. The tire T is a pneumatic tire including a pair of bead portions 1, sidewalls 2 each extending outward in a tire radial direction from a corresponding one of the bead portions 1, and a tread 3 contiguous to an outer end of each of the sidewalls 2 in the tire radial direction. Although not illustrated, a tread pattern according to required tire performance and use conditions is formed on an outer circumferential surface of the tread 3.

Here, the tire radial direction is a direction along a diameter of the tire T and corresponds to a vertical direction in FIG. 2. In FIG. 2, an upper side is an outer side in the tire radial direction, and a lower side is an inner side in the tire radial direction. The tire axial direction is a direction parallel to a rotation axis of the tire T and corresponds to a horizontal direction in FIG. 2. A side adjacent to a tire equatorial plane TC is an inner side in the tire axial direction, and a side remote from the tire equatorial plane TC is an outer side in the tire axial direction. The tire equatorial plane TC is a virtual plane located at a center of the tire T in the tire axial direction and orthogonal to the tire rotation axis. A tire circumferential direction is a direction around the rotation axis of the tire T.

A bead core 1a having an annular shape is embedded in each bead portion 1. The bead core 1a includes a bundle member such as steel wires covered with rubber. A bead filler 1b is disposed adjacent to an outer side of the bead core 1a in the tire radial direction. The bead filler 1b includes rubber having a triangular cross section extending outward in the tire radial direction from the bead core 1a. A carcass 4 is wound up from the inside to the outside in the tire axial direction so as to surround the bead core 1a and the bead filler 1b.

The tire T is a pneumatic radial tire including the carcass 4 having a radial structure extending in a toroidal shape across the pair of bead portions 1. The carcass 4 includes one or more carcass plies. The carcass ply includes carcass cords covered with a topping rubber, the carcass cords being paralleled in a direction intersecting the tire circumferential direction (for example, in a direction at an angle of 75 to 90 degrees with respect to the tire circumferential direction). As the carcass cords, organic fiber cords such as polyester cords, rayon cords, nylon cords, or aramid cords are preferably used.

A belt 5 for reinforcing the carcass 4 is embedded in the tread 3. The belt 5 is placed on an outer side of the carcass 4 in the tire radial direction. The belt 5 includes a plurality of belt plies. Each belt ply includes belt cords covered with a topping rubber, the belt cords being paralleled in a direction inclined relative to the tire circumferential direction (for example, a direction at an angle of around 20 degrees with respect to the tire circumferential direction). The plurality of belt plies are laminated such that their respective belt cords extend in different directions to intersect each other. As the belt cords, metal cords such as steel cords are preferably used.

A tire maximum width position 6 is a position where a profile of the side outer surface of the tire T is farthest from the tire equatorial plane TC in the tire axial direction. The profile of the side outer surface is a contour line corresponding to an outer surface of the sidewall 2 excluding a protrusion such as a rim protector, and usually has a meridian cross-sectional shape defined by smoothly connecting a plurality of arcs. A rim line 7 is provided adjacent to an inner side of the tire maximum width position 6 in the tire radial direction. The rim line 7 is formed by an annular protrusion formed along the tire circumferential direction. The rim line 7 is used in confirmation of whether a corresponding bead portion 1 is correctly attached to the rim.

A parting line 8 is provided adjacent to an outer side of the tire maximum width position 6 in the tire radial direction. The parting line 8 is formed by an annular protrusion formed along the tire circumferential direction. The protrusion has a triangular or trapezoidal cross section tapered outward in the tire axial direction, and has a ridgeline extending in the tire circumferential direction. The parting line 8 is set at a parting position between a mold for molding the sidewall 2 and a mold for molding the tread 3. In general, the parting position can be confirmed by a removal mark of a rubber burr generated in a fitting gap between these molds.

The tire T of which conicity deviates from a predetermined standard value in a uniformity inspection is to be reworked by the conicity correction device 10. As illustrated in FIG. 1, the conicity correction device 10 includes a base 11 installed on a floor surface 90 and a support leg 12 extending upward from the base 11 to support the heater 30. The base member 20 is attached to the heater 30 and is disposed at a height convenient for an operator to place the tire T. The tire T is horizontally placed on the base member 20 that has been heated and is heated with a side surface supported by the tire side support surface 40.

The heater 30 includes a jacket tank 31 filled with steam that serves as a heating medium, a feed line 32 through which steam is fed to the jacket tank 31, and a discharge line 33 through which the steam is discharged from the jacket tank 31. The feed line 32 is connected with a steam feed source 34. The jacket tank 31 includes a cylindrical body that is larger in outer diameter than the tire T and the base member 20. An upper portion of the jacket tank 31 is not insulated from heat, so that the heat of the steam is transferred to the base member 20. The base member 20 can be regulated in temperature by operation of valves 35 and 36 provided in the feed line 32 and the discharge line 33, respectively.

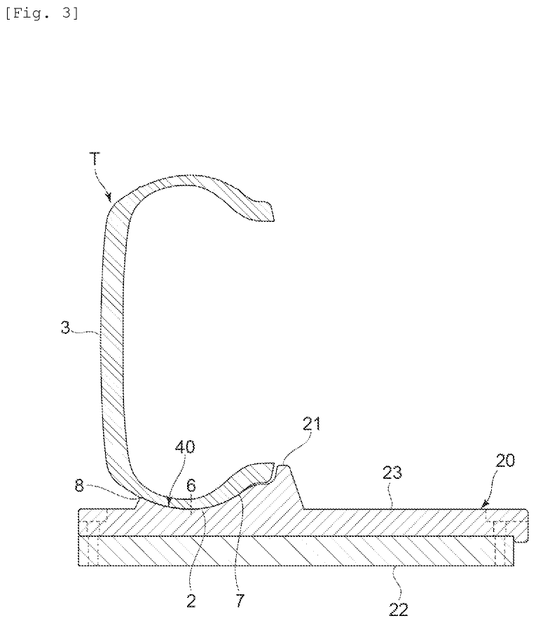

As illustrated in an enlarged manner in FIG. 3, the base member 20 includes a plate-like member. The base member 20 is formed in a disk shape that is larger in outer diameter than the tire T. The base member 20 includes a ring plate (donut plate) with an empty center (see FIG. 1). Making the center having a small contribution to heating empty reduces a surface area of the base member 20 to increase a heat-retention effect. The base member 20 includes a metal material such as iron. The base member 20 is fixed to (the jacket tank 31 of) the heater 30. The base member 20 is fixed to the heater 30 by, for example, welding, but may be fixed using a fastener such as a bolt.

The tire T is placed on the base member 20 with a tire half portion requiring correction facing downward, of a pair of tire half portions divided along the tire equatorial plane TC. Relatively slight conicity can be corrected by heating the tire half portion as described above without buffing. The conicity can be corrected even if the base member is a simple flat plate, but in this case, the vicinity of the tire maximum width position 6 is intensively heated, so that a rework time tends to be unnecessarily long, and a correction effect tends to be small. Therefore, in the device 10, a special shape is imparted to the tire side support surface 40 so as to allow heat to be efficiently transferred to a required area of the tire half portion.

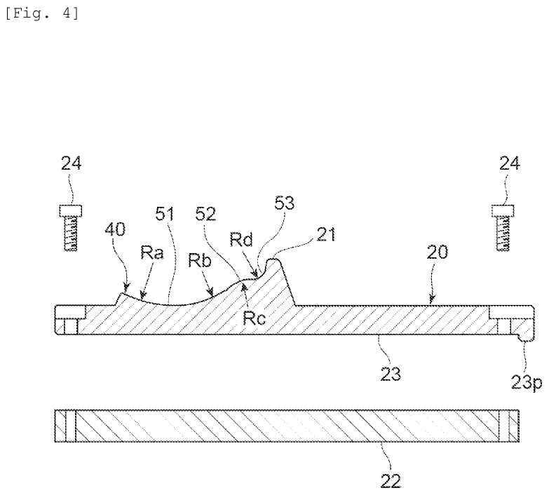

As illustrated in FIG. 4, the tire side support surface 40 includes a curved surface 51 (first curved surface) curved along the profile of the side outer surface of the tire T. Such a configuration allows heat to be efficiently transferred to the side outer surface of the tire half portion to increase the conicity correction effect. The curved surface 51 is curved outward in the tire axial direction (toward a lower side in FIG. 4). In other words, the curved surface 51 has a downwardly curved concave shape with respect to the vertical direction. The curved surface 51 may be formed by a single arc, but is preferably formed by a plurality of arcs having different curvatures and smoothly continuous to each other, as with a profile of a typical side outer surface. In the present embodiment, the curved surface 51 includes an arc having a curvature radius Ra and an arc having a curvature radius Rb. The curvature radius of each arc forming the curved surface 51 is, for example, 40 to 150 mm.

The curved surface 51 and the tire side support surface 40 including the curved surface 51 are formed in an annular shape along the tire circumferential direction. The curved surface 51 has a shape corresponding to an area around the tire maximum width position 6 of the side outer surface. In the example in FIG. 3, the curved surface 51 faces an area including a range from the rim line 7 to the parting line 8. From the viewpoint of increasing the conicity correction effect, the curved surface 51 preferably comes into contact with an area including a range of 35 mm outward in the tire radial direction from the tire maximum width position 6. From the same viewpoint, the curved surface 51 preferably comes into contact with an area including a range of 15 mm inward in the tire radial direction from the tire maximum width position 6.

The tire side support surface 40 also includes a curved surface 52 and a curved surface 53, as shown in FIG. 4. The curved surface 52 (second curved surface) curved inward in the tire axial direction (toward an upper side in FIG. 4). In other words, the curved surface 52 has an upwardly curved convex shape with respect to the vertical direction. The curved surface 52 is contiguous to an inner side of the curved surface 51 in the tire radial direction (to a right side in FIG. 4). The curved surface 52 has a shape corresponding to an outer surface of the bead portion 1 of the tire T. A curvature radius Rc of the curved surface 52 is smaller than the curvature radii Ra and Rb of the curved surface 51. The curved surface 53 (third curved surface) curved outward in the tire axial direction. In other words, the curved surface 53 has a downwardly curved concave shape with respect to the vertical direction. The curved surface 53 is contiguous to an inner side of the curved surface 52 in the tire radial direction. The curved surface 53 has a shape corresponding to a bead heel of the tire T. A curvature radius Rd of the curved surface 53 is smaller than the curvature radius Rc of the curved surface 52.

In the present embodiment, as illustrated in FIG. 3, when the tire T is placed on the base member 20, the outer surface of the bead portion 1 of the tire T is preferably separated from the base member 20. It is therefore possible to inhibit heat transfer to the outer surface of the bead portion 1 having a small contribution to conicity correction and efficiently transfer heat to the required area of the side outer surface. In the present embodiment, the tire T is separated from the base member 20 in an area ranging from the bead heel to the rim line 7 of the tire T. The configuration, however, is not limited to the above, and the outer surface of the bead portion 1 may be brought into contact with the base member 20.

The base member 20 includes a centering portion 21 provided adjacent to an inner side of the tire side support surface 40 in the tire radial direction and facing a bead bottom surface of the tire T. When the tire T is placed on the base member 20, centering of the tire T is performed by causing the centering portion 21 of the base member 20 to face the bead bottom surface of the tire T. The centering portion 21 extends annularly along the tire circumferential direction. The centering portion 21 is formed so as to be contiguous to the curved surface 53 and extend inward in the tire axial direction. The centering portion 21 is formed by a protrusion protruding inward in the tire axial direction.

The operator can confirm that the tire T is properly placed on the base member 20 on the basis of a relative positional relation between the bead bottom surface of the tire T placed on the base member 20 and the centering portion 21, a circumferential gap formed between the bead bottom surface of the tire T and the centering portion 21, or the like. If the tire T is not appropriately centered (centering) with respect to the tire side support surface 40 when the tire T is placed on the base member 20, the side outer surface may be irregularly deformed due to the curved surface shape of the tire side support surface 40, but centering the tire T as described above can prevent such inconvenience.

As illustrated in FIGS. 3 and 4, the base member 20 includes a main body portion 22 that is heated by the heater 30 and a detachable portion 23 detachable from the main body portion 22. The tire side support surface 40 is provided on the detachable portion 23. Such a configuration makes the shape of the tire side support surface 40 changeable by replacing the detachable portion 23, so that it is possible to flexibly adapt to various tire shapes and tire sizes. The detachable portion 23 is tightly fixed to the main body portion 22 with a bolt 24 as a fastener. It is therefore possible to appropriately heat the detachable portion 23 with excellent safety. The detachable portion 23 is provided with a positioning projection 23p for determining a position relative to the main body portion 22.

As illustrated in FIG. 3, the tire side support surface 40 is configured not to come into contact with an area (so-called a buttress area) on an outer side of the sidewall 2 of the tire T in the tire radial direction. In the present embodiment, the outer side of the sidewall 2 is separated from the base member 20 in an area outside the parting line 8 of the tire T in the tire radial direction. This makes it possible to inhibit heat transfer to an outer surface of the buttress area having a small contribution to conicity correction and efficiently transfer heat to the required area of the side outer surface. Further, it is also convenient for use in a tire slightly larger in size (for example, 20 to 21 inches) than an intended tire size (for example, 19 inch).

Upon lapse of a predetermined time after the tire T is placed on the base member 20, the tire T is removed from the conicity correction device 10 to terminate the heating. The tire thus heated is cooled to near room temperature by natural cooling and then subjected to the uniformity inspection again for measurement of uniformity including conicity. The tire T of which it is confirmed that each uniformity does not deviate from a corresponding predetermined standard value is returned to a shipment line as a tire that has been appropriately reworked.

In the present embodiment, an example where the tire side support surface 40 is provided on the protrusion formed on an upper surface of the base member 20 has been described, but the configuration is not limited to the example. Therefore, for example, the tire side support surface as described above may be provided on a hollow formed in the upper surface of the base member 20.

In the present embodiment, an example where the heater 30 heats the base member 20 by steam has been described, but the configuration is not limited to the example, and for example, a configuration using an electric heater, hot water, a gas burner, or the like may be employed.

[1]

As described above, the tire conicity correction device 10 of the present embodiment includes the base member 20 on which the tire T is horizontally placed with the tire axial direction coincident with the vertical direction, the heater 30 that heats the base member 20, and the tire side support surface 40 provided on the base member 20 to support the side outer surface of the tire T. The tire side support surface 40 includes the curved surface 51 curved along the profile of the side outer surface of the tire T. Such a configuration allows the conicity of the tire T to be corrected by a simple operation of placing the tire T on the base member 20. Moreover, since the tire side support surface 40 includes the curved surface 51 curved along the profile of the side outer surface of the tire T, heat can be efficiently transferred to the tire half portion.

[2]

In the conicity correction device 10 of the above [1], the base member 20 preferably includes the centering portion 21 provided adjacent to the inner side of the tire side support surface 40 in the tire radial direction and facing the bead bottom surface of the tire T. Such a configuration allows the tire T to be appropriately centered with respect to the tire side support surface 40, so that it is possible to avoid inconvenience due to positional displacement of the tire T.

[3]

In the conicity correction device 10 of the above [1] or [2], it is preferable that the base member 20 include the main body portion 22 that is heated by the heater 30 and the detachable portion 23 detachable from the main body portion 22, and the tire side support surface 40 be provided on the detachable portion 23. Such a configuration makes the shape of the tire side support surface 40 changeable by replacing the detachable portion 23, so that it is possible to flexibly adapt to various tire shapes and tire sizes.

[4]

A tire conicity correction method of the present embodiment includes horizontally placing the tire T on the base member 20 that has been heated with the tire axial direction coincident with the vertical direction and performing heating with the tire side support surface 40 of the base member 20 supporting the side outer surface of the tire T, and the tire side support surface 40 includes the curved surface 51 curved along the profile of the side outer surface of the tire T. Such a method allows the conicity of the tire T to be corrected by a simple operation of placing the tire T on the base member 20. Moreover, since the tire side support surface 40 includes the curved surface 51 curved along the profile of the side outer surface of the tire T, heat can be efficiently transferred to the tire half portion.

[5]

In the conicity correction method of the above [4], when the tire T is placed on the base member 20, the centering of the tire T is preferably performed by causing the centering portion 21 of the base member 20 to face the bead bottom surface of the tire T. Such a method allows the tire T to be appropriately centered with respect to the tire side support surface 40, so that it is possible to avoid inconvenience due to positional displacement of the tire T (deformation of the side outer surface by the tire side support surface 40).

[6]

In the conicity correction method of the above [4] or [5], when the tire T is placed on the base member 20, the outer surface of the bead portion 1 of the tire T is preferably separated from the base member 20. It is therefore possible to inhibit heat transfer to the outer surface of the bead portion 1 having a small contribution to conicity correction and efficiently transfer heat to the required area of the side outer surface.

The embodiment of the present disclosure has been described above. However, this embodiment should not limit specific configurations according to the present disclosure. The present disclosure provides a scope indicated by the above description of the embodiment as well as the claims, and further includes meanings equivalent to those of the claims and all modifications within the scope.

The conicity correction device and the conicity correction method of the present disclosure are not limited to the above-described embodiment at all, and various modifications and changes can be made without departing from the gist of the present disclosure. It is further possible to employ any combination of the configurations employed in the above-described embodiment.

What is claimed is:

1. A tire conicity correction device comprising:
a base member on which a tire is horizontally placed with a tire axial direction coincident with a vertical direction;
a heater configured to heat the base member; and
a tire side support surface provided on the base member to support a side outer surface of the tire, wherein
the tire side support surface includes a first curved surface curved along a profile of the side outer surface of the tire.

2. The tire conicity correction device according to claim 1, wherein
the base member includes a centering portion provided on an inner side of the tire side support surface in a tire radial direction and facing a bead bottom surface of the tire.

3. The tire conicity correction device according to claim 1, wherein
the base member includes a main body portion that is heated by the heater, and a detachable portion detachable from the main body portion, and
the tire side support surface is provided on the detachable portion.

4. The tire conicity correction device according to claim 1, wherein
the heater includes:
a jacket tank filled with a heating medium; and
a feed line to which a feed source of the heating medium is connected, the heating medium being fed to the jacket tank through the feed line.

5. The tire conicity correction device according to claim 1, wherein
the first curved surface faces an area including a range from a rim line to a parting line of the tire.

6. The tire conicity correction device according to claim 1, wherein
the first curved surface has a downwardly curved concave shape with respect to the vertical direction.

7. The tire conicity correction device according to claim 1, wherein
the tire side support surface further includes a second curved surface having an upwardly curved convex shape with respect to the vertical direction, and
the second curved surface is contiguous to an inner side of the first curved surface in a tire radial direction.

8. The tire conicity correction device according to claim 7, wherein
the second curved surface is smaller in curvature radius than the first curved surface.

9. The tire conicity correction device according to claim 7, wherein
the tire side support surface further includes a third curved surface having a downwardly curved concave shape with respect to the vertical direction, and
the third curved surface is contiguous to an inner side of the second curved surface in the tire radial direction.

10. The tire conicity correction device according to claim 9, wherein
the third curved surface is smaller in curvature radius than the second curved surface.

11. A tire conicity correction method comprising horizontally placing a tire on a base member that has been heated with a tire axial direction coincident with a vertical direction and performing heating with a tire side support surface of the base member supporting a side outer surface of the tire, wherein
the tire side support surface includes a first curved surface curved along a profile of the side outer surface of the tire.

12. The tire conicity correction method according to claim 11, wherein
when the tire is placed on the base member, centering of the tire is performed by causing a centering portion of the base member to face a bead bottom surface of the tire.

13. The tire conicity correction method according to claim 11, wherein
when the tire is placed on the base member, an outer surface of a bead portion of the tire is separated from the base member.

14. The tire conicity correction method according to claim 11, wherein
the base member is attached to a heater including a jacket tank filled with a heating medium.

15. The tire conicity correction method according to claim 11, wherein
the tire is placed on the base member with the tire not mounted on a rim.

16. The tire conicity correction method according to claim 11, wherein
the first curved surface faces an area including a range from a rim line to a parting line of the tire.

17. The tire conicity correction method according to claim 11, wherein
a buttress area of the tire placed on the base member is separated from the tire side support surface.

18. The tire conicity correction method according to claim 11, wherein
the first curved surface has a downwardly curved concave shape with respect to the vertical direction.

19. The tire conicity correction method according to claim 11, wherein
the tire side support surface further includes a second curved surface having an upwardly curved convex shape with respect to the vertical direction, and
the second curved surface is contiguous to an inner side of the first curved surface in the tire radial direction.

20. The tire conicity correction method according to claim 19, wherein
the tire side support surface further includes a third curved surface having a downwardly curved concave shape with respect to the vertical direction, and
the third curved surface is contiguous to an inner side of the second curved surface in the tire radial direction.
